(19) United States
(12) Patent Application Publication
(10) Pub. No.: US 2020/0065214 A1
(43) Pub. Date: Feb. 27, 2020

(54) APPLICATION PERFORMANCE SIMULATOR

(71) Applicant: INTERNATIONAL BUSINESS MACHINES CORPORATION, Armonk, NY (US)

(72) Inventors: Yasushi Negishi, Tokyo (JP); Kiyokuni Kawachiya, Kanagawa (JP); Jun Doi, Kanagawa-ken (JP)

(21) Appl. No.: 16/110,324

(22) Filed: Aug. 23, 2018

(51) Int. Cl. G06F 11/34; G06F 1/32; G06F 9/50

(52) U.S. Cl. CPC G06F 11/3457; G06F 11/3428; G06F 2209/501; G06F 9/5094; G06F 2201/865; G06F 1/324

(57) ABSTRACT

A computer-implemented method, system, and computer program product are provided to simulate a target system. The method includes determining system performance metrics for a target system and an execution system. The method also includes generating a ratio of estimation between the system performance metrics for the target system and the execution system. The method additionally includes throttling components in the execution system to adjust all of the system performance metrics of the execution system responsive to the ratio of estimation to create a throttled execution system. The method further includes measuring a throttled execution time while running an application on the throttled execution system. The method also includes estimating a target execution time for the application on the target system responsive to the throttled execution time.

### BACKGROUND

### Technical Field

The present invention generally relates to computer system simulation, and more particularly to simulating a target computer system with a throttled execution computer system.

### Description of the Related Art

Supercomputers can include a central processing unit (CPU) and a graphics processing unit (GPU). The main parts of the execution time of high-performance computing (HPC) applications are CPU-GPU data transfer and GPU calculation time.

It is important to estimate the performance on a new machine environment for application optimization and supercomputer business, as bids for large system procurements can require performance estimation of benchmark applications before the target system becomes available.

### SUMMARY

In accordance with an embodiment of the present invention, a computer-implemented method is provided to simulate a target system. The method includes allocating a private space for a first thread in a memory. The method includes determining system performance metrics for a target system and an execution system. The method also includes generating a ratio of estimation between the system performance metrics for the target system and the execution system. The method additionally includes throttling components in the execution system to adjust all of the system performance metrics of the execution system responsive to the ratio of estimation to create a throttled execution system. The method further includes measuring a throttled execution time while running an application on the throttled execution system. The method also includes estimating a target execution time for the application on the target system responsive to the throttled execution time.

In accordance with yet another embodiment, a non-transitory computer-readable storage medium comprising a computer-readable program for simulating a target system is presented. The non-transitory computer readable storage medium having program instructions. The program instructions executable by a computer to cause the computer to perform a method. The method includes determining system performance metrics for a target system and an execution system. The method also includes generating a ratio of estimation between the system performance metrics for the target system and the execution system. The method additionally includes throttling components in the execution system to adjust all of the system performance metrics of the execution system responsive to the ratio of estimation to create a throttled execution system. The method further includes measuring a throttled execution time while running an application on the throttled execution system. The method also includes estimating a target execution time for the application on the target system responsive to the throttled execution time.

In accordance with yet another embodiment, a target system simulator is provided. The system includes a memory and one or more processors in communication with the memory configured to determine system performance metrics for a target system and an execution system. The memory is further configured to generate a ratio of estimation between the system performance metrics for the target system and the execution system. The memory is additionally configured to throttle components in the execution system to adjust all of the system performance metrics of the execution system responsive to the ratio of estimation to create a throttled execution system. The memory is also configured to measure a throttled execution time while running an application on the throttled execution system. The memory is further configured to estimate a target execution time for the application on the target system responsive to the throttled execution time.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block/flow diagram showing an application performance simulator environment, in accordance with embodiments of the present invention;

FIG. 2 is a block/flow diagram showing a target system simulator, in accordance with embodiments of the present invention;

FIG. 3 is a block/flow diagram showing an exemplary target system simulator, in accordance with embodiments of the present invention;

FIG. 4 is an exemplary processing system, in accordance with embodiments of the present invention; and

FIG. 5 is a block diagram illustrating a method for target system simulation, in accordance with embodiments of the present invention.

### DETAILED DESCRIPTION

Performance on a new machine environment or a machine that is not currently available for the application optimization and supercomputer business can be estimated. Large system procurements bids need performance estimation of benchmark applications or a target application before the new machine environment or the machine that is not currently available becomes available. Performance estimation benchmark applications for a target application need to be as accurate as possible to ensure the new machine environment or the machine that is not currently available performs as advertised in a bid.

An application performance simulator can estimate application execution time on a new machine environment or a machine that is not currently available according to the execution time on an available machine, when system performance metrics along a critical path are different between the new machine environment or the machine that is not currently available and an available machine. The critical path is a sequence of stages determining a minimum time needed for an operation, especially when analyzing high-performance computing (HPC) applications. System performance metrics can include for example central processing unit (CPU)/graphics processing unit (GPU) calculation speeds, CPU-GPU/GPU-GPU communication speeds, and node-node communication speed, among others. Node-node communication speed can include communication between different nodes of the target system if the target system is located at multiple locations.

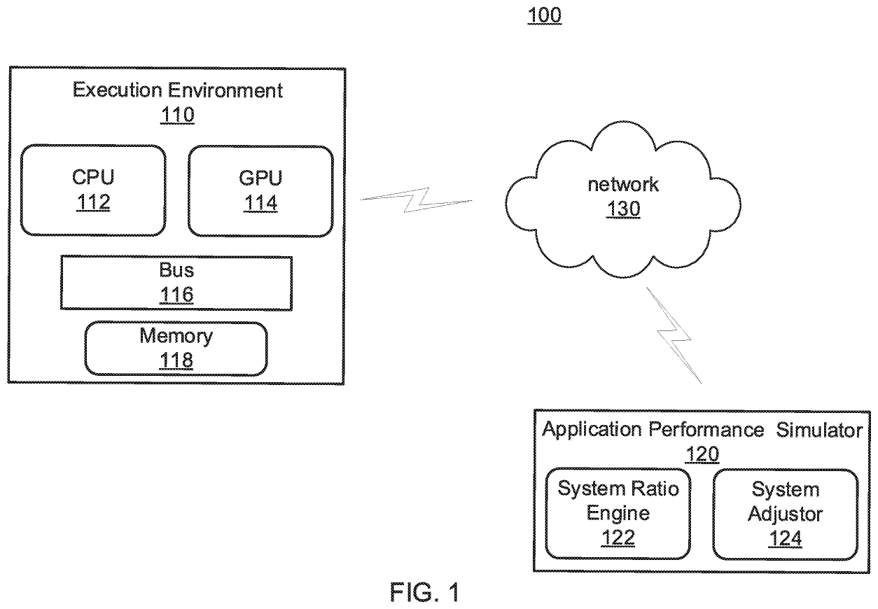

Referring now to the drawings in which like numerals represent the same or similar elements and initially to FIG. 1, a block/flow diagram of an application performance simulator environment 100 to which aspects of the present invention may be applied is shown in accordance with one embodiment. An application performance simulator 120 can include an execution environment 110 that can be employed to measure application's execution time to estimate the application execution time in a target environment. The application performance simulator 120 can include system ratio engine 122 and a system adjustor 124. The system ratio engine 122 can calculate the ratios of components in systems. The system adjustor 124 can adjust the system components to get a certain performance. The execution environment 110 can include a CPU 112 and a GPU 114 where clocks of the CPU 112 and clocks of the GPU 114 can be changed. The execution environment 110 can include a system bus 116 and a memory 118 that can be adjusted by the system adjustor 124 to slow the communication speed between components in the execution environment 110. The clocks of the CPU 112, the clocks of the GPU 114, and the CPU-GPU and GPU-GPU communication speeds can be adjusted or throttled by the system adjustor 124 to make the ratios of the system performance metrics between the execution environment 110 and the target environment the same for all the system performance metrics. The CPU execution speed and the GPU execution speed on the execution system can be adjusted by a tool or setting, e.g., changing the multiplier of the CPU 112, changing the voltage to the CPU 112, etc. The CPU-GPU and GPU-GPU communication speed on the execution system can be adjusted by a tool or setting, e.g., emulate slower communication links by modifying the function to extend the transfer time by adjusting a speed of a bus 116 or memory 118. One way to extend the transfer time is to transfer the data multiple times, e.g., 1.2 times.

The ratios of the system performance metrics can be determined by the system ratio engine 122. The ratios of the system performance metrics can include CPU execution speed on the target environment/CPU execution speed on the execution environment, GPU execution speed on the target environment/GPU execution speed on the execution environment, CPU-GPU communication speed on the target environment/CPU-GPU communication speed on the execution environment, GPU-GPU communication speed on the target environment/GPU-GPU communication speed on the execution environment, etc. Accordingly, the critical path on the execution environment is adjusted to equal the critical path on the target environment, and an estimate of the execution time on the target environment can be more accurately measured. In the embodiment shown in FIG. 1, the elements thereof are interconnected by a network(s) 130. However, in other embodiments, other types of connections (e.g., wired, etc.) can also be used.

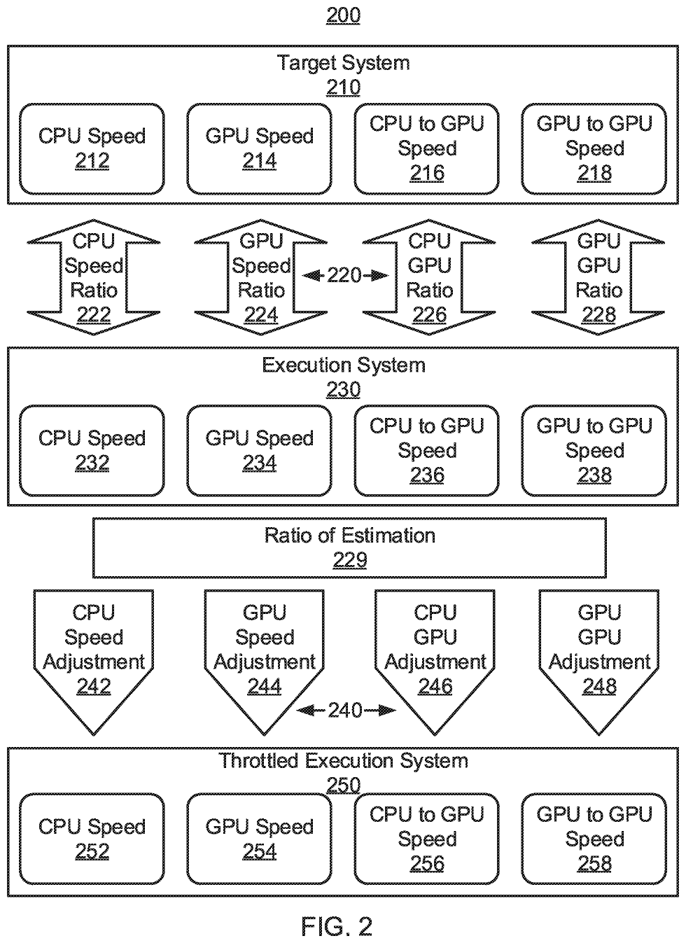

FIG. 2 is a block/flow diagram of a target system simulator 200 to which aspects of the present invention may be applied is shown in accordance with one embodiment. The target system simulator 200 can include a target system 210. The target system 210 can be any system that is unavailable for testing or a proposed system to be tested for performance in the high-performance computing (HPC) application area or other computing fields. The target system 210 can include a central processing unit (CPU), a graphics processing unit (GPU), a communication bus, input/output devices, storage, random access memory, read only memory, etc. The CPU of the target system 210 can be assigned a CPU speed 212 based on the execution speed of the CPU in the target system. The CPU speed 212 can depend on the CPU in the target system 210, the bus speed in the target system 210, the memory in the target system 210, etc. The target system 210 can be assigned a GPU speed 214 based on the execution speed of the GPU in the target system 210. The GPU speed 214 can depend on the GPU in the target system 210, the bus speed in the target system 210, the memory in the target system 210, etc.

The target system 210 can be assigned a CPU to GPU speed 216 based on the communication speed between the CPU and the GPU in the target system 210. The CPU to GPU speed 216 can depend on the CPU in the target system 210, GPU in the target system 210, the bus speed in the target system 210, the memory in the target system 210, etc. The target system 210 can be assigned a GPU to GPU speed 218 based on the communication speed in the GPU in the target system 210. The GPU to GPU speed 218 can depend on the GPU in the target system 210, the bus speed in the target system 210, the memory in the target system 210, etc.

The CPU of the execution system 230 can be assigned a CPU speed 232 based on the execution speed of the CPU in the execution system. The CPU speed 232 can depend on the CPU in the execution system 230, the bus speed in the execution system 230, the memory in the execution system 230, etc. The execution system 230 can be assigned a GPU speed 234 based on the execution speed of the GPU in the execution system 230. The GPU speed 234 can depend on the GPU in the execution system 230, the bus speed in the execution system 230, the memory in the execution system 230, etc.

The execution system 230 can be assigned a CPU to GPU speed 236 based on the communication speed between the CPU and the GPU in the execution system 230. The CPU to GPU speed 236 can depend on the CPU in the execution system 230, GPU in the execution system 230, the bus speed in the execution system 230, the memory in the execution system 230, etc. The execution system 230 can be assigned a GPU to GPU speed 238 based on the communication speed in the GPU in the execution system 230. The GPU to GPU speed 238 can depend on the GPU in the execution system 230, the bus speed in the execution system 230, the memory in the execution system 230, etc.

In one embodiment, target to execution ratios 220 can be calculated. The target to execution ratios 220 can include a CPU speed ratio 222, a GPU speed ratio 224, a CPU to GPU ratio 226, and a GPU to GPU ratio 228. The CPU speed ratio 222 can be the CPU speed 212 of the target system 210 divided by the CPU speed 232 of the execution system 230. In one example, the CPU speed ratio 222 can be <CPU speed ratio>:=CPU execution speed on the target environment/CPU execution speed on the initial execution environment. The GPU speed ratio 224 can be the GPU speed 214 of the target system 210 divided by the GPU speed 234 of the execution system 230. In one example, the GPU speed ratio 224 can be <GPU speed ratio>:=GPU execution speed on the target environment/GPU execution speed on the initial execution environment. The CPU to GPU ratio 226 can be the CPU to GPU speed 216 of the target system 210 divided by the CPU to GPU speed 236 of the execution system 230. In one example, the CPU to GPU speed 226 can be <CPU-GPU speed ratio>:=CPU-GPU communication speed on the target environment/CPU-GPU communication speed on the initial execution environment. The GPU to GPU ratio 228 can be the GPU to GPU speed 218 of the target system 210 divided by the GPU to GPU speed 238 of the execution system 230. In one example, the GPU to GPU ratio 228 can be <GPU-GPU speed ratio>:=GPU-GPU communication speed on the target environment/GPU-GPU communication speed on the initial execution environment.

The target to execution ratios 220 can be employed to calculate a ratio for estimation 229. The ratio for estimation 229 can be the maximum of the CPU speed ratio 222, the GPU speed ratio 224, the CPU to GPU ratio 226, and the GPU to GPU ratio 228. In one example, the ratio of estimation 229 can be <Ratio for Estimation>:=MAX(<CPU speed ratio>,<GPU speed ratio>,<CPU-GPU speed ratio>,<GPU-GPU speed ratio>). The ratio of estimation 229 can be employed to calculate an execution adjustment 240. The execution adjustment 240 can include a CPU speed adjustment 242, a GPU speed adjustment 244, a CPU to GPU adjustment 246, and a GPU to GPU adjustment 248. The CPU speed adjustment 242 can be the CPU speed 232 of the execution system 230 divided by the ratio of estimation 229. The GPU speed adjustment 244 can be the GPU speed 234 of the execution system 230 divided by the ratio of estimation 229. The CPU to GPU adjustment 246 can be the CPU to GPU speed 236 of the execution system 230 divided by the ratio of estimation 229. The GPU to GPU adjustment 248 can be the GPU to GPU speed 238 of the execution system 230 divided by the ratio of estimation 229. The execution adjustment 240 can be the level to adjust the execution system 230 to simulate the target system 210.

The execution adjustment 240 can be employed to adjust the execution system 230 to a throttled execution system 250. The throttled execution system 250 can have the CPU 112, the GPU 114, the bus 116, input/output devices, storage, the memory 118, etc. adjusted to perform at a fixed ratio of the target system 210. The fixed ratio can be the ratio of estimation 229. The throttled execution system 250 can include a CPU speed 252 for the throttled execution system 250 responsive to the adjustment to the CPU, the bus speed, and the memory. In one example, the CPU speed 252 on the throttled execution system 250 can be <CPU execution speed>:=<CPU speed on the target environment>/<CPU speed on the execution environment>. The throttled execution system 250 can include a GPU speed 254 for the throttled execution system 250 responsive to the adjustment to the GPU, the bus speed, and the memory. In one example, the GPU speed 254 on the throttled execution system 250 can be <GPU execution speed>:=<GPU speed on the target environment>/<GPU speed on the execution environment>. The throttled execution system 250 can include a CPU to GPU speed 256 for the throttled execution system 250 responsive to the adjustment to the CPU, the GPU, the bus speed, and the memory. In one example, the CPU to GPU speed 256 on the throttled execution system 250 can be <CPU-GPU communication speed>:=<CPU-GPU communication speed on the target environment>/<CPU-GPU communication speed on the execution environment>. The throttled execution system 250 can include a GPU to GPU speed 258 for the throttled execution system 250 responsive to the adjustment to the GPU, the bus speed, and the memory. In one example, the GPU to GPU speed 258 on the throttled execution system 250 can be <GPU-GPU communication speed>:=<GPU-GPU communication speed on the target environment>/<GPU-GPU communication speed on the execution environment>.

The throttled execution system 250 can run any application to calculate an application performance result. The application performance result on the throttled execution system 250 can be utilized to calculate the application performance results for the application on the target system 210 by multiplying the application performance result from the throttled execution system 250 by the ratio of estimation 229. The application performance result calculated for the target system 210 is a real-world estimation for the performance of the target system 210 utilizing existing throttled hardware to match the unique combination of CPU speed 212, GPU speed 214, CPU to GPU speed 216, and GPU to GPU speed 218 of the target system 210 without testing on the actual target system.

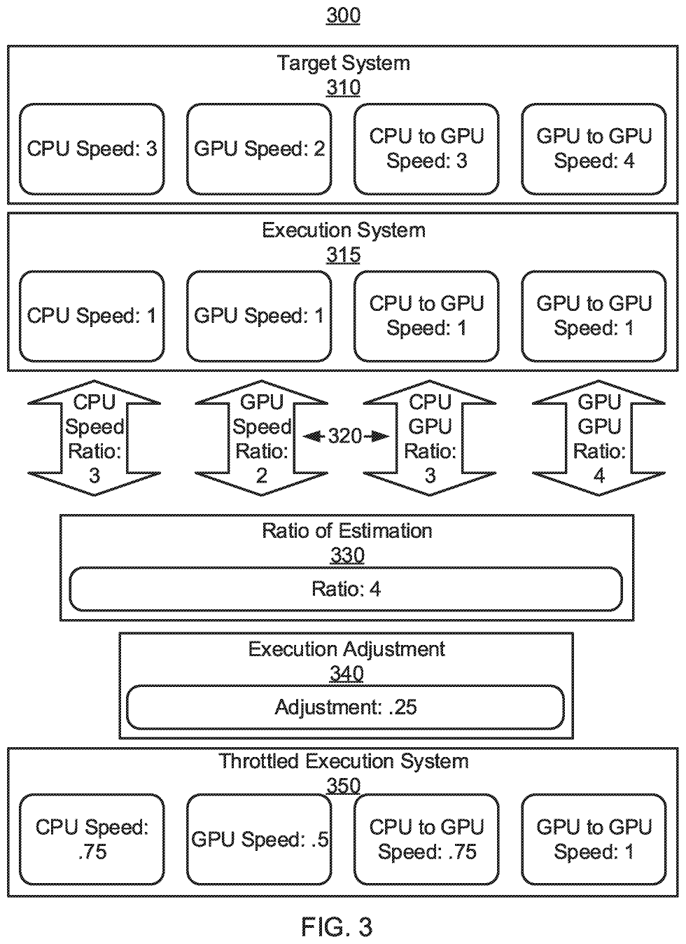

FIG. 3 is a block/flow diagram of an exemplary target system simulator 300, in accordance with an embodiment of the present invention. The target system simulator 300 can be employed to estimate the performance of a target system 310 by running applications on a throttled execution system 350. The performance of running the application can be an execution time of running the application (e.g., 243 milliseconds (ms)). The throttled execution system 350 can be an execution system 315 after setting on the execution system 315 have been adjusted to model the performance of the target system 310. The estimated performance on the throttled execution system 350 will be pre-defined fraction of the performance on the target system 310. The pre-defined fraction can include a ratio of estimation 330. The target system simulator 300 permits the running of application on systems that are not available for testing, whether the system is out of stock or a design for a future release.

The target system simulator 300 can include the target system 310. The target system 310 can include the CPU 112, the GPU 114, the bus 116, input/output devices, storage, the memory 118, read only memory, etc. The target system 310 can include a multitude of speed rating, some examples include a CPU speed rating, a GPU speed rating, a CPU to GPU speed rating, and a GPU to GPU speed rating. In one example, the target system 310 can include a CPU speed rating of 3, a GPU speed rating of 2, a CPU to GPU speed rating of 3, and a GPU to GPU rating of 4. The target system simulator 300 can include the execution system 315. The execution system 315 can include the CPU 112, the GPU 114, the bus 116, input/output devices, storage, the memory 118, read only memory, etc. The execution system 315 can include a multitude of speed rating, some examples include a CPU speed rating, a GPU speed rating, a CPU to GPU speed rating, and a GPU to GPU speed rating. In one example, the execution system 315 can include a CPU speed rating of 1, a GPU speed rating of 1, a CPU to GPU speed rating of 1, and a GPU to GPU rating of 1.

The speed ratings of the target system 310 and the execution system 315 can be calculated in as target to execution ratios 320. In one embodiment, the target to execution ratios 320 can include the CPU speed of the target system 310: the CPU speed of the execution system 315. In another embodiment, the target to execution ratios 320 can include the GPU speed of the target system 310: the GPU speed of the execution system 315. In yet another embodiment, the target to execution ratios 320 can include the CPU to GPU speed of the target system 310: the CPU to GPU speed of the execution system 315. In still another embodiment, the target to execution ratios 320 can include the GPU to GPU speed of the target system 310: the GPU to GPU speed of the execution system 315. In one example, the target to execution ratios 320 can include a CPU speed ratio of 3:1, a GPU speed ratio of 2:1, a CPU to GPU speed ratio of 3:1, and a GPU to GPU speed ratio of 4:1. In another example, the CPU speed ratio, the GPU speed ratio, the CPU to GPU speed ratio, and the GPU to GPU speed ratio can include integers, fractions, floating point numbers, etc.

The target to execution ratios 320 can be employed to calculate the ratio of estimation 330. The ratio of estimation can take the maximum of the calculated target to execution ratios 320 as the ratio of estimation 330. The maximum ratio is selected because the execution system cannot be adjusted to run faster than the execution system speeds for simulating a possibly faster target system. In one example, the target to execution ratios 320 can include 3:1, 2:1, 3:1, and 4:1. In this example, the ratio of estimation 330 can be 4:1 or 4. The ratio of estimation 330 can be utilized to calculate an execution adjustment 340. The execution adjustment 340 can be the reciprocal of the ratio of estimation 330. In one example, the ratio of estimation 330 can be 4 and the execution adjustment 340 can be the reciprocal of 4. In this example, the execution adjustment 340 can be ¼ or 0.25. The execution adjustment 340 is utilized when adjusting or throttling the execution system 315 to be consistent with the speeds of the target system 310. The throttled execution system 350 can be implemented by adjusting the speeds in the execution system 315 to mirror the ratios of the speeds in the target system 310. The mirroring of the ratios of the speeds in the target systems can be accomplished by multiplying the speeds in the target system 310 by the execution adjustment 340. This permits at least one speed rating in the execution system to remain constant, while other speed ratings can be throttled to perform at a fraction of the speed rating.

In one example, the execution system 315 GPU to GPU speed rating is 1 with the target system 310 GPU to GPU speed rating is 4. In this example, the target system 310 GPU to GPU speed rating (4) multiplied by the execution adjustment 340 (0.25) is equal to 1 or the execution system 315 GPU to GPU speed rating. This example would require no throttling or adjustment to the GPU to GPU speed rating of the execution system 315 to the simulation. In another example, the execution system 315 CPU to GPU speed rating is 1 with the target system 310 CPU to GPU speed rating is 3. In this example, the target system 310 CPU to GPU speed rating (3) multiplied by the execution adjustment 340 (0.25) is equal to 0.75. This example would require the CPU to GPU speed to be throttled in the execution system 315 to 0.75 for the simulation. The throttled execution system 350 in this example can have a CPU to GPU speed rating of 0.75.

In yet another example, the execution system 315 GPU speed rating is 1 with the target system 310 GPU speed rating is 2. In this example, the target system 310 GPU speed rating (2) multiplied by the execution adjustment 340 (0.25) is equal to 0.5. This example would require the GPU speed to be throttled in the execution system 315 to 0.5 for the simulation. The throttled execution system 350 in this example can have a GPU speed rating of 0.5. In still another example, the execution system 315 CPU speed rating is 1 with the target system 310 CPU speed rating is 3. In this example, the target system 310 CPU speed rating (3) multiplied by the execution adjustment 340 (0.25) is equal to 0.75. This example would require the CPU speed to be throttled in the execution system 315 to 0.75 for the simulation. The throttled execution system 350 in this example can have a CPU speed rating of 0.75.

The throttled execution system 350 can be utilized to run applications to measure performance of the application on the throttled execution system 350. In one example, the performance of running the application on the throttled execution system 350 can be 400 ms. For this example, the performance of running the application on the execution system 315 can be 290 ms. This example has the throttled execution system 350 performing slower than the execution system 315, which should be obvious since the throttled execution system 350 is the execution system 315 throttled into a slower machine. The performance of running the application on the throttled execution system 350 can be utilized to estimate the performance of running the application on the target system 310.

The performance of running the application on the target system 310 can be calculated by multiplying the performance of running the application on the throttled execution system 350 by the ratio of estimation 330. Since the throttled execution system 350 is running at a known fraction of the target system 310, the performance of the target system 310 can be estimated dividing the performance of the throttled execution system 350 by the inverse of the known fraction, the inverse of the known fraction being the ratio of estimation 330. In one example, the throttled execution system 350 performance can be 400 ms with the ratio of estimation being 4. In this example, the performance of the target system 310 running the application would be 400 ms divided by 4 or 100 ms. The target system 310 with a performance of 100 ms in this example is a vast improvement to the execution system 315 with a performance of 290 ms. This target system simulator 300 permits performance testing of applications on a target machine based on a set of speed ratings on a throttled machine without having the target machine.

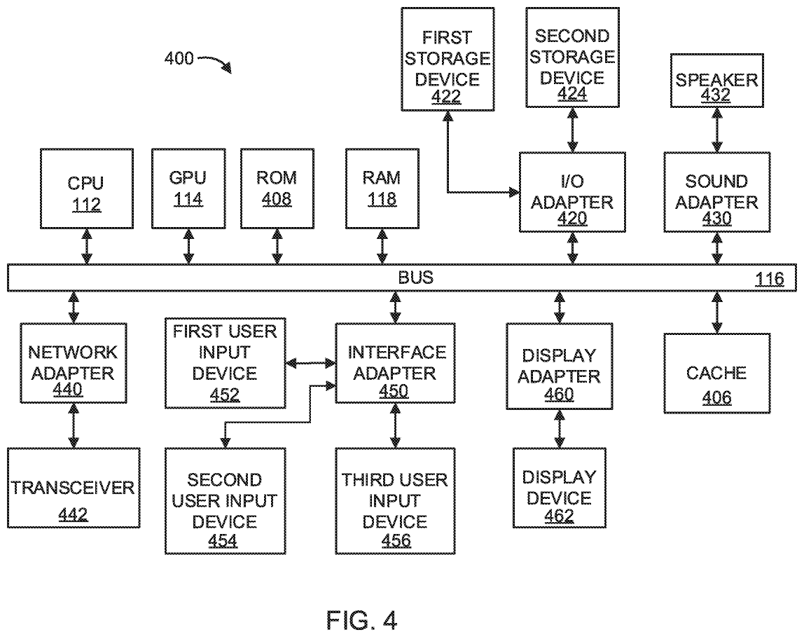

FIG. 4 is an exemplary processing system 400, in accordance with embodiments of the present invention. The processing system 400 includes at least one processor (CPU) 112 operatively coupled to other components via a system bus 116. The CPU 112 performance can be adjusted or throttled for testing purposes. The processing system 400 includes at least one graphics processor (GPU) 114 operatively coupled to other components via a system bus 116. The GPU 114 performance can be adjusted or throttled for testing purposes. A cache 406, a Read Only Memory (ROM) 408, a Random Access Memory (RAM) 118, an input/output (I/O) adapter 420, a sound adapter 430, a network adapter 440, a user interface adapter 450, and a display adapter 460, are operatively coupled to the system bus 116. The performance of the ROM 408, RAM 118, and system bus 116 can be adjusted or throttled for testing purposes.

A first storage device 422 and a second storage device 424 are operatively coupled to system bus 116 by the I/O adapter 420. The storage devices 422 and 424 can be any of a disk storage device (e.g., a magnetic or optical disk storage device), a solid state magnetic device, and so forth. The storage devices 422 and 424 can be the same type of storage device or different types of storage devices.

A speaker 432 is operatively coupled to system bus 116 by the sound adapter 430. A transceiver 442 is operatively coupled to system bus 116 by network adapter 440. A display device 462 is operatively coupled to system bus 116 by display adapter 460.

A first user input device 452, a second user input device 454, and a third user input device 456 are operatively coupled to system bus 116 by user interface adapter 450. The user input devices 452, 454, and 456 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 452, 454, and 456 can be the same type of user input device or different types of user input devices. The user input devices 452, 454, and 456 are used to input and output information to and from system 400.

Of course, the processing system 400 may also include other elements (not shown), as readily contemplated by one of skill in the art, as well as omit certain elements. For example, various other input devices and/or output devices can be included in processing system 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 400 are readily contemplated by one of ordinary skill in the art given the teachings of the present invention provided herein.

Moreover, it is to be appreciated that part or all of processing system 400 may be implemented in one or more of the elements of the target system simulator 200 and/or in one or more of the elements of the target system simulator 300 and/or at least part of the target system 210 of FIG. 2 and/or at least part of the target system 310 of FIG. 3 and/or at least part of the execution system 230 of FIG. 2 and/or at least part of the execution system 315 of FIG. 3.

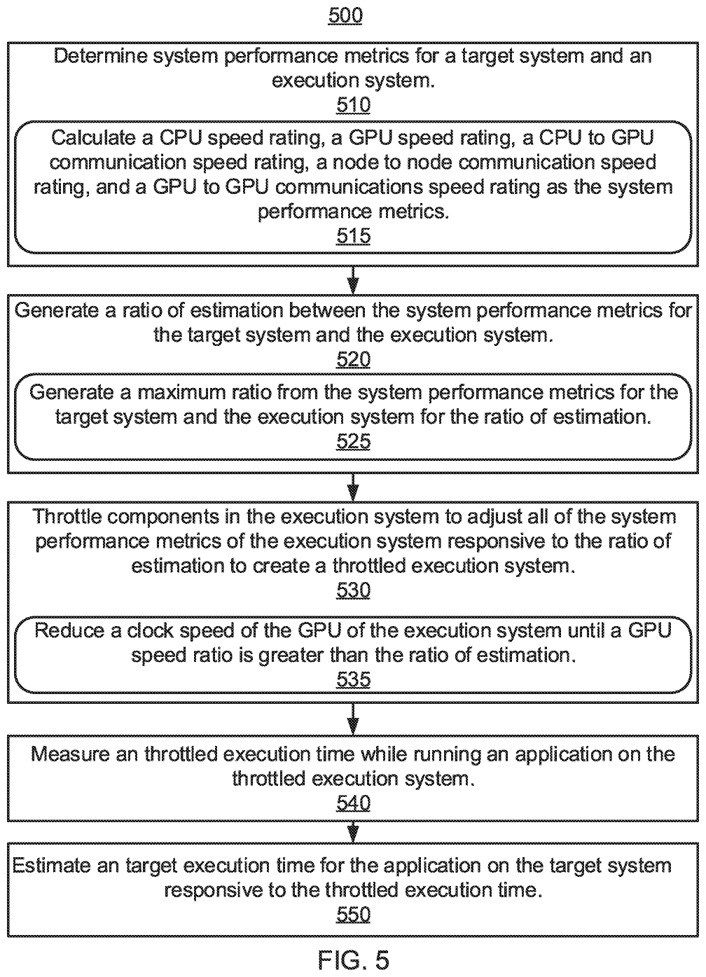

Further, it is to be appreciated that processing system 400 may perform at least part of the method described herein including, for example, at least part of method 500 of FIG. 5.

Referring now to FIG. 5, a block diagram illustrating a method for target system simulation, in accordance with embodiments of the present invention. In block 510, determine system performance metrics for a target system and an execution system. In block 515, calculate a CPU speed rating, a GPU speed rating, a CPU to GPU communication speed rating, a node to node communication speed rating, and a GPU to GPU communications speed rating as the system performance metrics. In block 520, generate a ratio of estimation between the system performance metrics for the target system and the execution system. In one example, the ratio of estimation can be <Ratio for Estimation>. In block 525, generate a maximum ratio from the system performance metrics for the target system and the execution system for the ratio of estimation. In block 530, throttle components in the execution system to adjust all of the system performance metrics of the execution system responsive to the ratio of estimation to create a throttled execution system. In block 535, reduce a clock speed of the GPU of the execution system until a GPU speed ratio is greater than the ratio of estimation. In block 540, measure a throttled execution time while running an application on the throttled execution system. In one example, the measured throttled execution time can be <Measured execution Time>. In block 550, estimate a target execution time for the application on the target system responsive to the throttled execution time. In one example, the estimated target execution time can be <Estimated execution time>:=<Measured execution Time>*<Ratio for Estimation>. This estimated execution time will accurately represent the execution time for the target application on the target environment.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of systems and methods for application performance simulation (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method for target system simulation, the computer-implemented method comprising:
determining system performance metrics for a target system and an execution system;
generating a ratio of estimation between the system performance metrics for the target system and the execution system;
throttling components in the execution system to adjust all of the system performance metrics of the execution system responsive to the ratio of estimation to create a throttled execution system;
measuring a throttled execution time while running an application on the throttled execution system; and
estimating a target execution time for the application on the target system responsive to the throttled execution time.

2. The computer-implemented method of claim 1, wherein determining includes calculating a central processing unit (CPU) speed rating, a graphics processing unit (GPU) speed rating, a CPU to GPU communication speed rating, and a GPU to GPU communications speed rating as the system performance metrics.

3. The computer-implemented method of claim 1, wherein determining includes calculating a node to node communication speed rating as the system performance metrics.

4. The computer-implemented method of claim 1, wherein generating includes generating a maximum ratio from the system performance metrics for the target system and the execution system for the ratio of estimation.

5. The computer-implemented method of claim 1, wherein throttling includes reducing a clock speed of the CPU.

6. The computer-implemented method of claim 1, wherein throttling includes reducing a clock speed of the GPU.

7. The computer-implemented method of claim 1, wherein throttling includes reducing a clock speed of the GPU of the execution system until a GPU speed ratio is greater than the ratio of estimation.

8. The computer-implemented method of claim 1, wherein estimating includes multiplying the throttled execution time by the ratio of estimation.

9. A non-transitory computer-readable storage medium comprising a computer-readable program executed on a processor in a data processing system to simulate a target system, wherein the computer-readable program when executed on the processor causes a computer to perform the steps of:
determining system performance metrics for a target system and an execution system;
generating a ratio of estimation between the system performance metrics for the target system and the execution system;
throttling components in the execution system to adjust all of the system performance metrics of the execution system responsive to the ratio of estimation to create a throttled execution system;
measuring a throttled execution time while running an application on the throttled execution system; and
estimating a target execution time for the application on the target system responsive to the throttled execution time.

10. The non-transitory computer-readable storage medium of claim 9, wherein the generating includes generating a maximum ratio from the system performance metrics for the target system and the execution system for the ratio of estimation.

11. The non-transitory computer-readable storage medium of claim 9, wherein throttling includes reducing a clock speed of the GPU of the execution system until a GPU speed ratio is greater than the ratio of estimation.

12. The non-transitory computer-readable storage medium of claim 9, wherein estimating includes multiplying the throttled execution time by the ratio of estimation.

13. A target system simulator, the simulator comprising:
a memory; and
one or more processors in communication with the memory, the memory including program code configured to:
determine system performance metrics for a target system and an execution system;
generate a ratio of estimation between the system performance metrics for the target system and the execution system;
components in the execution system to adjust all of the system performance metrics of the execution system responsive to the ratio of estimation to create a throttled execution system;
measure a throttled execution time while running an application on the throttled execution system; and
estimate a target execution time for the application on the target system responsive to the throttled execution time.

14. The simulator of claim 13, wherein the program code is further configured to calculate a central processing unit (CPU) speed rating, a graphics processing unit (GPU) speed rating, a CPU to GPU communication speed rating, and a GPU to GPU communications speed rating as the system performance metrics.

15. The simulator of claim 13, wherein the program code is further configured to calculate a node to node communication speed rating as the system performance metrics.

16. The simulator of claim 13, wherein the program code is further configured to generate a maximum ratio from the system performance metrics for the target system and the execution system for the ratio of estimation.

17. The simulator of claim 13, wherein the program code is further configured to reduce a clock speed of the CPU.

18. The simulator of claim 13, wherein the program code is further configured to reduce a clock speed of the GPU.

19. The simulator of claim 13, wherein the program code is further configured to reduce a clock speed of the GPU of the execution system until a GPU speed ratio is greater than the ratio of estimation.

20. The simulator of claim 13, wherein the program code is further configured to multiply the throttled execution time by the ratio of estimation.
